(19) United States
(12) Patent Application Publication
(10) Pub. No.: US 2026/0292344 A1
(43) Pub. Date: Sep. 24, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: AKIRA KOSUGE, Tokyo (JP); GOU YAMASHITA, Kanagawa (JP)

(21) Appl. No.: 19/566,552

(22) Filed: Mar. 13, 2026

(30) Foreign Application Priority Data
Mar. 24, 2025 (JP) 2025-048079

(51) Int. Cl. H04N 23/695; H04N 23/611; H04N 23/667; H04N 23/69

(52) U.S. Cl. CPC H04N 23/695; H04N 23/611; H04N 23/667; H04N 23/69

(57) ABSTRACT

An information processing apparatus includes at least one processor, and a memory storing instructions that cause the at least one processor to control an image capturing unit in a first mode to include, within an angle of view of the image capturing unit, a predetermined number of tracking target objects set to be tracked, and control the image capturing unit in a second mode to include, within the angle of view of the image capturing unit, one or more tracking target objects including a representative target object, the second mode being different from the first mode. When the representative target object exists outside a control switching region set within the angle of view of the image capturing unit, the image capturing unit is controlled in the first mode. When the representative target object exists within the control switching region, the image capturing unit is controlled in the second mode.

### BACKGROUND

### Field of the Technology

The present disclosure relates to an information processing apparatus configured to control an image capturing apparatus configured to track a subject, an information processing method, and a storage medium.

### Description of the Related Art

A conventional technique exists in which a tracking target object that is a subject determined as a target to be tracked and imaged is detected in an image generated based on imaging by an image capturing unit and the detected tracking target object is tracked and imaged. Further, another technique exists in which when an image capturing unit tracks a tracking target object to capture an image of the tracking target object, it is determined whether continuation of tracking is permitted, based on the position of the tracking target object in an imaging region, thereby switching tracking control in a case where the tracking target object moves in a direction away from the imaging region. Japanese Patent Laid-Open No. 2020-005122 describes a method in which the position of a tracking target object in an imaging region is detected, and in a case where the detected position is lost in an outer edge region of the imaging region, control is switched so that the image capturing unit does not perform tracking, thereby imaging a tracking target object within the imaging region, excluding the tracking target object moving away from the imaging region.

### SUMMARY

According to an aspect of the present disclosure, an information processing apparatus includes at least one processor, and a memory storing instructions that cause the at least one processor to control an image capturing unit in a first mode to include, within an angle of view of the image capturing unit, a predetermined number of tracking target objects set to be tracked including a representative target object, and control the image capturing unit in a second mode to include, within the angle of view of the image capturing unit, one or more tracking target objects including the representative target object, the second mode being different from the first mode, wherein, in a case where the representative target object exists outside a control switching region set within the angle of view of the image capturing unit, the image capturing unit is controlled in the first mode, and wherein, in a case where the representative target object exists within the control switching region, the image capturing unit is controlled in the second mode.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an overall configuration of an image capturing system.

FIG. 2 is a diagram illustrating a hardware configuration of a camera and a hardware configuration of a controller.

FIG. 3A is a diagram illustrating a functional configuration of the camera, and FIG. 3B is a diagram illustrating a functional configuration of the controller.

FIGS. 4A-4D are diagrams illustrating relationships between captured images and indicators calculated by a calculation unit of the camera.

FIG. 5 is a sequence diagram illustrating a process from captured image transmission from the camera to the controller to tracking target object setting by the camera.

FIGS. 6A and 6B are flowcharts illustrating a tracking process.

FIG. 7A is a diagram illustrating an outer edge region of an imaging region of the camera, and FIG. 7B is a diagram illustrating a result of performing tracking control on an image capturing unit to prioritize a representative target object.

FIGS. 8A and 8B are flowcharts illustrating a tracking process.

FIG. 9 is a diagram illustrating a user interface for tracking control switching.

### DESCRIPTION OF THE EMBODIMENTS

### First Embodiment

An embodiment of the present disclosure will be described with reference to the drawings.

According to the technique described in Japanese Patent Laid-Open No. 2020-005122, even in a case where a tracking target object with a high imaging priority moves away from an imaging region, tracking is performed while excluding the tracking target object. As a result, control may not be performed as intended by a user capturing an image. Thus, the present disclosure is directed to providing an information processing apparatus, a method, and a program for reliably tracking a tracking target object with a high imaging priority.

As described above, the technique described in Japanese Patent Laid-Open No. 2020-005122 may fail to fully track a tracking target object with a high imaging priority, and control may not be performed as intended by the user. Accordingly, the present embodiment is configured so that a subject is tracked within a region predefined as an imaging region, and in a case where a main imaging target exits the imaging region, imaging is performed to include the main imaging target within an angle of view of the image capturing unit. Furthermore, the present embodiment is configured so that a plurality of tracking target objects is tracked by an image capturing unit, and in a case where a representative tracking target object (hereinafter, "representative target object") of the plurality of tracking target objects is about to exit the imaging region, the image capturing unit is controlled to include the representative target object within the angle of view of the image capturing unit.

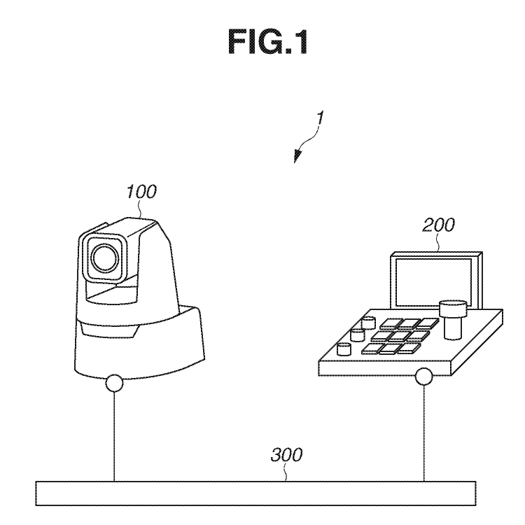

FIG. 1 is a diagram illustrating an overall configuration of an image capturing system 1. The image capturing system 1 detects a plurality of tracking target objects, tracks the plurality of detected tracking target objects, and captures an image of the plurality of tracking target objects. A tracking target object is a subject predetermined as a tracking target for an image capturing unit. Examples of tracking target objects include a person. In the present embodiment, a case is assumed in which each of a plurality of subjects is a tracking target object while it is desirable to minimize loss of a representative target object among the plurality of tracking target objects. In this case, an image capturing unit is required to perform an operation, such as zooming, so that the plurality of tracking target objects is within an angle of view of the image capturing unit. However, in a case where consideration is given solely to ensuring that the plurality of tracking target objects is within the angle of view of the image capturing unit, for example, when the image capturing unit zooms out as the plurality of tracking target objects is spatially dispersed, the size of each tracking target object may become too small in an image, which may result in an undetected tracking target object. At this time, it may become difficult to track the plurality of tracking target objects. Further, even if zooming is stopped when a predetermined size is reached to prevent the size from becoming too small, for example, the plurality of spatially dispersed tracking target objects may exit the angle of view, which may also cause difficulty in tracking each of the plurality of tracking target objects. Thus, in the present embodiment, tracking control is switched in a case where a tracking condition is unsatisfied, thereby continuing tracking at least the representative target object selected from the plurality of tracking target objects.

The image capturing system 1 includes a camera 100 and a controller 200. The camera 100 and the controller 200 are connected to each other via a network 300.

The camera 100 as an example of an image capturing unit operates to generate an image by performing an image capturing operation, detect a plurality of tracking target objects from the generated image, track the plurality of detected tracking target objects, and capture an image of each tracking target object. Examples of operations performed by the camera 100 include panning, tilting, and zooming operations.

Further, the zooming operation of the camera 100 includes zoom-in and zoom-out operations. An image generated by an image capturing operation performed by the camera 100 may also be referred to as a captured image hereinafter. Further, the camera 100 may also be regarded as an information processing apparatus.

The controller 200 as an example of an information processing apparatus controls the camera 100. The controller 200 according to the present embodiment acquires a captured image and a detection result from the camera 100 for a subject contained in the captured image and displays the acquired information to receive a selection of a subject as a tracking target object by the user. Further, the controller 200 sets the selected subject as a tracking target object and transmits information indicating the set tracking target object to the camera 100.

The camera 100 and the controller 200 may be implemented by a single computer or may be realized by distributed processing performed by a plurality of computers.

The network 300 is realized by, for example, a local area network (LAN), such as the Internet, a wide area network (WAN), or other networks. Further, the network 300 is not limited to the Internet and may be a telephone line, a dedicated digital line, or an Asynchronous Transfer Mode (ATM). Furthermore, the network 300 may be realized by a Frame Relay line, a cable television line, a wireless line for data broadcasting, or any combination thereof.

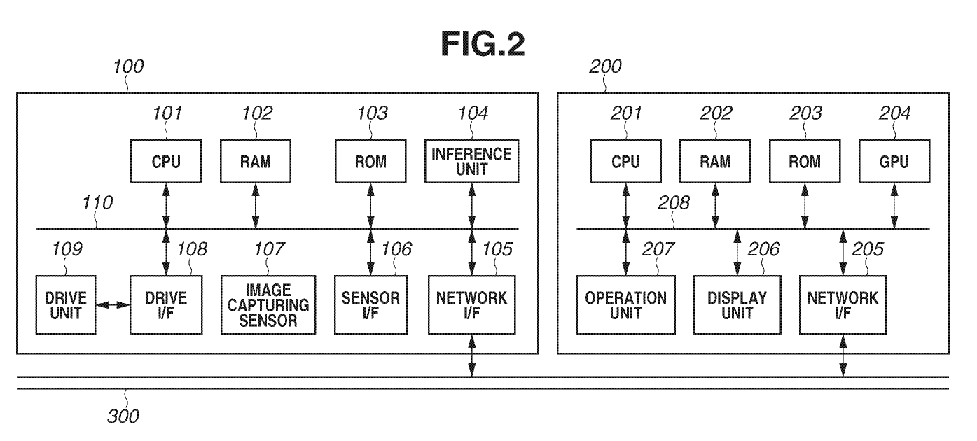

FIG. 2 is a diagram illustrating a hardware configuration of the camera 100 and a hardware configuration of the controller 200.

The camera 100 includes a central processing unit (CPU) 101, a random access memory (RAM) 102, a read-only memory (ROM) 103, an inference unit 104, a network interface (network I/F) 105, a sensor interface (sensor I/F) 106, an image capturing sensor 107, a drive interface (drive I/F) 108, and a drive unit 109. The CPU 101, the RAM 102, the ROM 103, the inference unit 104, the network I/F 105, the sensor I/F 106, the image capturing sensor 107, the drive I/F 108, and the drive unit 109 are connected to one another via a bus 110.

The CPU 101 controls the entire camera 100 by performing various processes using a computer program and data stored in the RAM 102. The RAM 102 is a high-speed storage device, such as a dynamic RAM (DRAM), and stores a computer program loaded from the ROM 103, a captured image, and various types of information, such as information acquired from the controller 200. Further, the RAM 102 includes a work area used by the CPU 101 and the inference unit 104 during execution of various processes. The ROM 103 is a non-volatile storage device, such as a flash memory, a hard disk drive (HDD), a solid state drive (SSD), or a Secure Digital (SD) card, and stores setting data of the camera 100, a computer program and data for startup and basic operation of the camera 100, and the like. The ROM 103 further stores a computer program and data for causing the CPU 101 or the inference unit 104 to perform or control various processes described as processes performed by the camera 100. The inference unit 104 performs an inference process to determine whether a subject is present in a captured image, to estimate a subject region, and the like. For example, the inference unit 104 is a computing device dedicated to image processing and inference processing, such as a graphics processing unit (GPU). Another computing device, such as a field programmable gate array (FPGA), may be used in place of the inference unit 104. Further, the CPU 101 may perform processing performed by the inference unit 104. The network I/F 105 is an interface for connecting to the network 300 and communicates with an external device, such as the controller 200, via a communication medium, such as Ethernet. The sensor I/F 106 converts an image signal output from the image capturing sensor 107 into a captured image, which is data in a predetermined format, compresses the converted captured image when necessary, and then outputs the image to the RAM 102. The sensor I/F 106 may perform various processes, such as image quality adjustment, such as color correction, exposure correction, and sharpness correction, and a cropping process to extract only a predetermined region, on an image represented by an image signal acquired from the image capturing sensor 107. Further, these processes performed by the sensor I/F 106 may be performed based on an instruction received from the controller 200 via the network I/F 105. The image capturing sensor 107 receives incident light from a subject, converts the received light into electric charge, and outputs an image signal based on the conversion result. Examples of the image capturing sensor 107 include a photodiode, a charge-coupled device (CCD) sensor, and a complementary metal oxide semiconductor (CMOS) sensor. The drive I/F 108 is an interface for transmitting and receiving an instruction signal, such as a control signal, to and from the drive unit 109.

The drive unit 109 is a drive mechanism for changing an image capturing direction of the camera 100 and includes a mechanical drive system and a drive source such as a motor. The drive unit 109 performs panning and tilting operations to change the image capturing direction horizontally and vertically and performs a zooming operation to optically change an image capturing angle of view based on an instruction received from the CPU 101 via the drive I/F 108.

Further, the controller 200 includes a CPU 201, a RAM 202, a ROM 203, a GPU 204, a network I/F 205, a display unit 206, and an operation unit 207. The CPU 201, the RAM 202, the ROM 203, the GPU 204, the network I/F 205, the display unit 206, and the operation unit 207 are connected to one another via a bus 208.

The CPU 201 controls the entire controller 200 by performing various processes using a computer program and data stored in the RAM 202. The RAM 202 is a high-speed storage device, such as a DRAM. The RAM 202 stores a computer program and data loaded from the ROM 203 and various types of data acquired from the camera 100. Further, the RAM 202 includes a work area used by the CPU 201 and the GPU 204 during execution of various processes. The ROM 203 is a non-volatile storage device, such as a flash memory, an HDD, a SSD, or a SD card, and stores setting data of the controller 200, a computer program and data for startup and basic operation of the controller 200, and the like. The ROM 203 further stores a computer program and data for causing the CPU 201 or the GPU 204 to control various processes. The GPU 204 performs an inference process to determine whether a subject is present in a captured image, to estimate a subject region, and the like. For example, the GPU 204 is a computing device dedicated to image processing and inference processing, such as a GPU. Another computing device, such as an FPGA, may be used in place of the GPU 204. Further, the CPU 201 may perform processing performed by the GPU 204. The network I/F 205 is an interface for connecting to the network 300 and communicates with an external device, such as the camera 100, via a communication medium, such as Ethernet. The display unit 206 includes a screen, such as a liquid crystal screen or a touch panel screen, and displays a captured image acquired from the camera 100, a setting screen of the controller 200, and the like. In an image capturing system 1, instead of providing the display unit 206 to the controller 200, a display apparatus (not illustrated) configured to display information may be connected to the controller 200, and a captured image and the setting screen of the controller 200 may be displayed on the display apparatus. The operation unit 207 is a user interface configured to receive a user operation on the controller 200, and examples include a button, a dial, a joystick, and a touch panel.

The controller 200 may be a personal computer (PC) including a mouse and a keyboard as the operation unit 207.

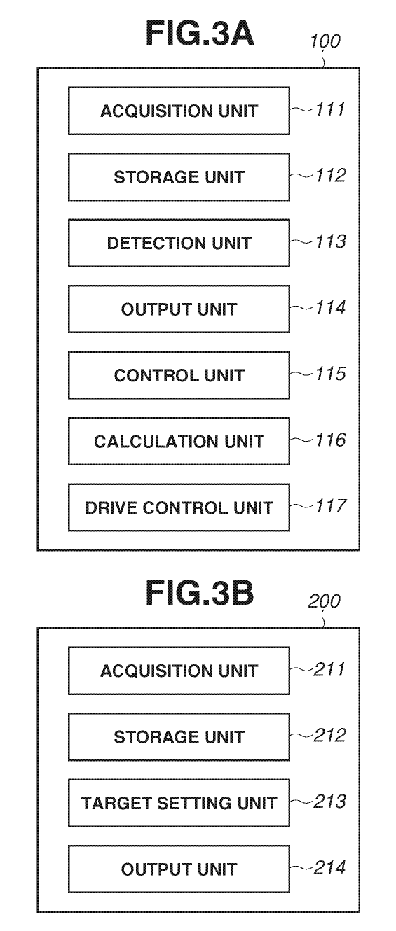

FIG. 3A is a diagram illustrating a portion of a functional configuration of the camera 100 pertaining to a feature of the present embodiment. The camera 100 includes an acquisition unit 111, a storage unit 112, a detection unit 113, an output unit 114, a control unit 115, a calculation unit 116, and a drive control unit 117.

The acquisition unit 111 acquires information from the controller 200. Examples of information acquired by the acquisition unit 111 include information indicating a subject set as a tracking target object.

The storage unit 112 corresponds to the ROM 103 and stores information acquired by the acquisition unit 111 and information generated by the camera 100, such as a captured image.

The detection unit 113 detects a subject, such as a human figure, from a captured image acquired by the image capturing sensor 107 and detects a subject region in the captured image. Examples of a subject region in a captured image include a subject size in the captured image, a subject length in the captured image, and a subject position in the captured image. The detection unit 113 estimates the subject from the input captured image by performing an inference process using a trained model generated using a machine learning scheme, such as deep learning, and outputs information representing coordinates corresponding to the subject region as a result. Examples of coordinates corresponding to a subject region include coordinates corresponding to the entire subject or a portion thereof in a captured image. Further, examples of coordinates corresponding to a portion of a subject include coordinates corresponding to a subject contour and coordinates corresponding to a head portion or face of a subject that is a human figure. Further, examples of coordinates corresponding to a portion of a subject include coordinates corresponding to top-left and bottom-right corners of a rectangle detected as a region corresponding to a subject by the detection unit 113, coordinates of a center of the rectangle, coordinates corresponding to a width direction of the rectangle, and coordinates corresponding to a height direction of the rectangle. The detection unit 113 herein may also be regarded as a subject detection unit configured to detect a specific subject from a captured image. Examples of a specific subject include a subject of a type predetermined as a candidate for a tracking target object, such as a human figure, a vehicle, or an animal. Further, the detection unit 113 may also be regarded as a position detection unit configured to detect a position of a tracking target object in a captured image.

The subject detection scheme employed by the detection unit 113 is not limited to the scheme using machine learning. The detection unit 113 may use a template matching method in which a template image including a detection target subject and a captured image are compared and a region in the captured image that has a high degree of similarity to the subject included in the template image is detected as a region indicative of the subject. Further, the detection unit 113 may use any subject detection scheme. Further, a subject to be detected by the detection unit 113 may be an object different from a human figure.

Further, the detection unit 113 identifies each detected subject by detecting a feature of the detected subject and generates subject identification information for each identified subject. The detection unit 113 performs an inference process using a trained model generated using a machine learning scheme, such as deep learning, thereby outputting information representing a feature value of the subject as a result based on an input captured image and a subject region in the input captured image. A feature value extracted by the detection unit 113 may be a feature value of the entire subject or a feature value of a portion of a subject, such as a head portion or face of a human figure. Further, examples of a feature value of a subject include a feature vector of an image. In this case, a machine learning model configured to use captured images generated by imaging from various angles for each subject as training images, label images containing the same subject with the same identifier (ID), use the images as input, and output a feature vector may be used. The detection unit 113 may use any trained model for subject identification.

The subject identification scheme employed by the detection unit 113 is not limited to the scheme using machine learning. The detection unit 113 may predict a subject region in the latest captured image using a Kalman filter or the like based on a transition of subject regions in previous consecutive captured images, and identify a subject closest to the predicted region as the same subject. Further, the detection unit 113 may use any subject identification scheme.

The detection unit 113 generates information representing coordinates corresponding to a subject region and information representing a feature value of a subject based on subject detection and stores the generated information in the storage unit 112. The information representing coordinates corresponding to a subject region and the information representing a feature value of a subject, which are generated by the detection unit 113, are both regarded as a result of detecting a subject in a captured image by the detection unit 113.

The output unit 114 outputs information to the controller 200. Examples of information output by the output unit 114 include a captured image and information indicating a result of detecting a subject in the captured image by the detection unit 113.

The control unit 115 extracts a tracking target object from the captured image. The control unit 115 extracts a tracking target object from at least one of information transmitted from the controller 200 as information indicating a subject set as a tracking target object and a detection result obtained by the detection unit 113 from a captured image. Further, in the present embodiment, in a case where a captured image contains a plurality of subjects, the control unit 115 extracts at least some of the plurality of subjects contained in the captured image as a tracking target object. After extracting a tracking target object, the control unit 115 stores information indicating which of the subjects detected by the detection unit 113 is a tracking target object in the storage unit 112.

The calculation unit 116 calculates a reference position and size of the plurality of tracking target objects extracted by the control unit 115 as a tracking target group in a captured image based on a set mode described below. A calculation scheme employed by the calculation unit 116 will be described below.

The drive control unit 117 as an example of a control unit controls operations of the drive unit 109 (refer to FIG. 2) of the camera 100, such as panning, tilting, and zooming. In a case where the drive control unit 117 in the present embodiment controls the drive unit 109 to perform zooming, the drive control unit 117 controls zooming performed by the drive unit 109 so that the camera 100 can continue tracking each of the plurality of tracking target objects extracted by the control unit 115. In other words, in a case where zooming performed by the drive unit 109 causes the camera 100 to lose tracking of any of the plurality of tracking target objects extracted by the control unit 115, the drive control unit 117 restricts zooming. For example, restricting zooming refers to limiting the range of angles of view achievable by zoom control. Specifically, as an example of restricting zooming, zooming toward a wide-angle direction is stopped in a case where the size of a tracking target object with respect to the captured image becomes excessively small. On the other hand, in a case where the size of a tracking target object with respect to the captured image becomes excessively large, zooming toward a telephoto direction is stopped. Further, at a limit of the zooming operation, further zooming is stopped.

The processes performed by the acquisition unit 111, the detection unit 113, the output unit 114, the control unit 115, the calculation unit 116, and the drive control unit 117 of the camera 100 are realized by the CPU 101 or the inference unit 104 by loading a program stored in the ROM 103 onto the RAM 102 and executing the loaded program. Further, the storage unit 112 of the camera 100 is realized by the RAM 102 or the ROM 103.

FIG. 3B is a diagram illustrating a functional configuration of the controller 200. The controller 200 includes an acquisition unit 211, a storage unit 212, a target setting unit 213, and an output unit 214.

The acquisition unit 211 acquires information from the camera 100. Examples of information acquired by the acquisition unit 211 include a captured image and information indicating a detection result obtained by the detection unit 113 of the camera 100 from the captured image.

The storage unit 212 stores information acquired by the acquisition unit 211 and information generated by the controller 200.

The target setting unit 213 sets a tracking target object. The target setting unit 213 displays a captured image transmitted from the camera 100, information indicating a subject detected in the captured image by the detection unit 113, and other information on the display unit 206 (refer to FIG. 2) of the controller 200. Then, the target setting unit 213 receives a user selection of a tracking target object based on the information displayed on the display unit 206 and sets a subject selected by the user as a tracking target object. Further, the target setting unit 213 generates information indicating which of the subjects is set as a tracking target object, and stores the generated information in the storage unit 212.

The output unit 214 outputs information to the camera 100 or the controller 200. Examples of information output from the output unit 214 to the camera 100 include information generated by the target setting unit 213 as information indicating which of the subjects is set as a tracking target object. Further, examples of information output from the output unit 214 to the controller 200 include an image displayed on the display unit 206.

The processes performed by the acquisition unit 211, the target setting unit 213, and the output unit 214 of the controller 200 are realized by the CPU 201 or the GPU 204 by loading a program stored in the ROM 203 onto the RAM 202 and executing the loaded program. Further, the storage unit 212 of the controller 200 is realized by the RAM 202 or the ROM 203.

One or more functional blocks illustrated in FIGS. 3A and 3B may be realized by hardware, such as an application-specific integrated circuit (ASIC) or a programmable logic array (PLA), or may be realized by a programmable processor, such as a CPU or a microprocessor unit (MPU), by executing software. Further, one or more functional blocks illustrated in FIGS. 3A and 3B may be realized by a combination of software and hardware. Accordingly, in the following description, even in a case where different functional blocks are described as operating units, the operating units may be realized by the same hardware.

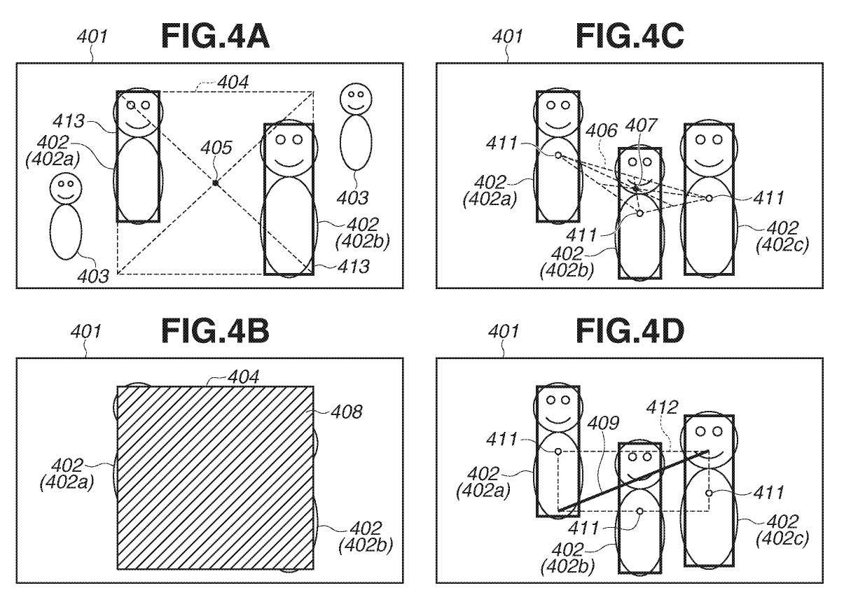

FIGS. 4A-4D are diagrams illustrating relationships between captured images and indicators calculated by the calculation unit 116 of the camera 100.

FIG. 4A illustrates a captured image 401. Further, in the captured image 401, a plurality of tracking target objects 402 consisting of tracking target objects 402a and 402b and a plurality of non-tracking target objects 403, none of which is a tracking target object, are illustrated. The plurality of tracking target objects 402 consisting of the tracking target objects 402a and 402b is a tracking target group herein.

Further, in the captured image 401 illustrated in FIG. 4A, rectangle images 413 are displayed on a region superimposed on the tracking target object 402a and on a region superimposed on the tracking target object 402b. The rectangle images 413 are rectangular images indicating regions of the tracking target objects 402 detected by the detection unit 113.

The calculation unit 116 calculates a reference position for the tracking target group from the captured image 401 illustrated in FIG. 4A. More specifically, the calculation unit 116 calculates a rectangular region 404 encompassing the rectangle image 413 for each tracking target object 402 and calculates a central region of the calculated rectangular region 404 as a reference position 405 for the tracking target group.

Further, as illustrated in FIG. 4B, the calculation unit 116 calculates a rectangle area 408 corresponding to the area of the calculated rectangular region 404 as the size of the tracking target group.

Schemes employed by the calculation unit 116 to calculate the reference position for the tracking target group and the size of the tracking target group are not limited to the examples described above. For example, the reference position 405 for the tracking target group may be calculated and determined based on a centroid position of the plurality of tracking target objects.

In the captured image 401 illustrated in FIG. 4C, the plurality of tracking target objects 402 consisting of the tracking target objects 402a, 402b, and 402c, i.e., the tracking target group, is illustrated. Further, in FIG. 4C, the rectangle image 413 is illustrated for each tracking target object 402. In this case, the calculation unit 116 may calculate, for each rectangle image 413, a central region 411, which is a central region of the region surrounded by the rectangle image 413, and calculate coordinates as mean values of coordinates corresponding to the calculated central regions 411 as a reference position 407 for the tracking target group. In this case, the coordinates as the mean values of the coordinates corresponding to the calculated central regions 411 may be calculated using a weighted average of the coordinates corresponding to the central regions 411. Consequently, the reference position for the tracking target group is closer to a region where more tracking target objects of the tracking target group are present.

Thus, in a case where, for example, the drive unit 109 of the camera 100 performs an operation using the reference position for the tracking target group as a target position, it becomes possible to perform an operation targeting the region where more tracking target objects of the tracking target group are present.

In a case where the tracking target group consists of three or more tracking target objects 402 as in the example illustrated in FIG. 4C, coordinates corresponding to a centroid region of a polygon 406 having each central region 411 as a corner match the coordinates as the mean values of the coordinates corresponding to the calculated central regions 411. Accordingly, the coordinates corresponding to the centroid region of the polygon 406 may be calculated as the reference position 407 for the tracking target group.

Further, in a case where the central regions 411 are calculated, the calculation unit 116 calculates a rectangular region 412 encompassing the central regions 411 as illustrated in FIG. 4D. Then, the calculation unit 116 may calculate a ratio of a width of the rectangular region 412 to a width of the captured image 401 and a ratio of a height of the rectangular region 412 to a height of the captured image 401 and may determine the larger one of the calculated ratios as the size of the tracking target group. The width of the captured image 401 and the width of the rectangular region 412 herein refer to horizontal lengths in the figure. Further, the height of the captured image 401 and the height of the rectangular region 412 herein refer to vertical lengths in the figure. In the illustrated example, the ratio of the width of the rectangular region 412 to the width of the captured image 401 is larger than the ratio of the height of the rectangular region 412 to the height of the captured image 401. Thus, the ratio of the width of the rectangular region 412 to the width of the captured image 401 is determined as the size of the tracking target group. Determining the size of the tracking target group as described above makes it possible to control the operation of the drive unit 109 of the camera 100 based on the size of the tracking target group along one of the horizontal and vertical directions in which the tracking target group is more widely spread in the captured image 401.

The calculation unit 116 may determine a ratio of a diagonal line 409 of the rectangular region 412 to a diagonal line of an outer frame of the captured image 401 as the size of the tracking target group. Further, the calculation unit 116 may determine an evaluation value obtained using at least some of the width and height of the rectangular region 412 and a length of the diagonal line 409 as the size of the tracking target group.

Further, the calculation unit 116 stores information representing the calculation results in the storage unit 112.

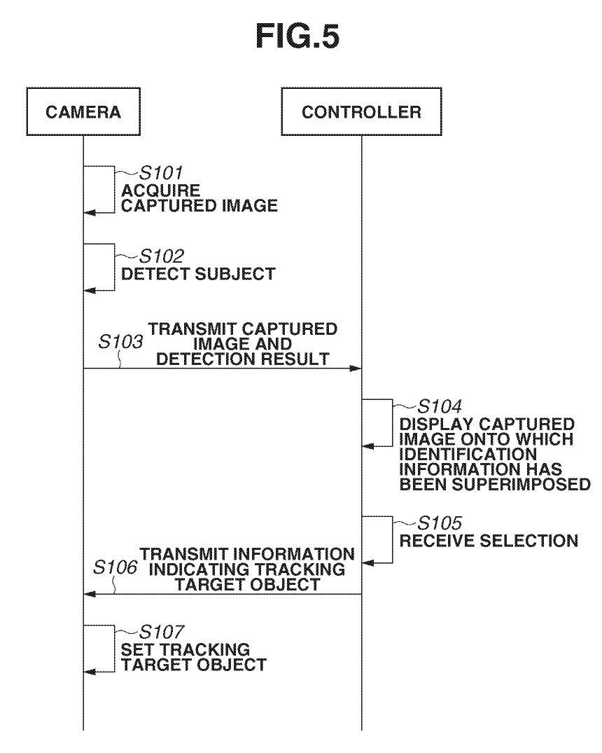

FIG. 5 is a sequence diagram illustrating a flow of operations including starting up the camera 100, instructing the camera 100 to start imaging or recording, causing the camera 100 to transmit a captured image to the controller 200, and setting a tracking target object for the camera 100. In the present embodiment, for example, the sequence is performed repeatedly every predetermined number of frames until the camera 100 is instructed to stop imaging or recording.

First, in step S101, the acquisition unit 111 of the camera 100 acquires a captured image captured by the image capturing sensor 107 and generated by the sensor I/F 106. The captured image acquired by the acquisition unit 111 is stored in the storage unit 112.

In step S102, the detection unit 113 of the camera 100 detects the presence of a subject in the captured image acquired by the acquisition unit 111 and detects a subject region in the captured image. Further, the detection unit 113 identifies the subject by detecting a feature of the subject and generates subject identification information. The detection unit 113 stores detection result information including the subject identification information, such as region information (such as coordinate information) about a region detected as a region corresponding to the subject, in the storage unit 112.

In step S103, the output unit 114 of the camera 100 transmits the captured image acquired by the acquisition unit 111 and the detection result information obtained by the detection unit 113 to the controller 200.

In step S104, the output unit 214 of the controller 200 displays the captured image transmitted from the camera 100 and the subject identification information regarding the detected subject on the display unit 206. More specifically, the output unit 214 displays, on the display unit 206, the captured image onto which the subject identification information (such as a frame indicating the region corresponding to the subject or a peaking display in which an edge of the region corresponding to the subject is emphasized so that the region is distinguishable) has been superimposed.

In step S105, the target setting unit 213 receives a user selection of a subject in the captured image displayed on the display unit 206 as a tracking target object.

In step S106, the target setting unit 213 transmits information indicating the tracking target object selected by the user to the camera 100 via the output unit 214.

In step S107, the control unit 115 of the camera 100 sets a tracking target object based on the information transmitted from the controller 200 in step S106. Therefore, the control unit 115 may also be regarded as a setting unit configured to set a plurality of tracking target objects to be tracked during image capture by the camera 100. Further, the control unit 115 stores information indicating the set tracking target object in the storage unit 112. Further, the present embodiment includes a mode in which the target setting unit 213 automatically sets at least one of the plurality of subjects detected by the detection unit 113 as tracking target objects, forms a tracking target group, and controls the camera 100 to include the plurality of tracking target objects included in the tracking target group within the angle of view. Further, the target setting unit 213 may set an upper limit for the number of tracking target objects based on a specification of the camera 100, a specification of the controller 200, or a user setting. For example, the target setting unit 213 adds and sets tracking target objects based on a user designation via the controller 200 or a subject detection result from the detection unit 113 until a predetermined number set by the user is reached. Alternatively, the target setting unit 213 adds and sets tracking target objects until an upper limit predetermined by the camera 100 or the controller 200 is reached.

The process illustrated in FIG. 5 may be performed each time the camera 100 performs imaging and generates a captured image. Then, each time a tracking target object is selected by the user, the camera 100 and the controller 200 may update the tracking target object setting.

Further, while an example in which a subject selected by the user is set as a tracking target object is described above, examples of setting a tracking target object are not limited to the above-described example. For example, the target setting unit 213 may set a subject of a predetermined type detected in a captured image as a tracking target object. Examples of the predetermined type include person, vehicle, and animal. Further, after a single subject is selected by the user and set as a tracking target object, the target setting unit 213 may set a subject near (within a predetermined range of) the single tracking target object selected by the user in the captured image as a tracking target object. Further, the target setting unit 213 may set a subject having a feature similar to a feature of the single tracking target object selected by the user in the captured image as a tracking target object. This reduces the burden on the user to set a tracking target object, compared to a case where selection by the user is required for any tracking target object that is a target of the setting.

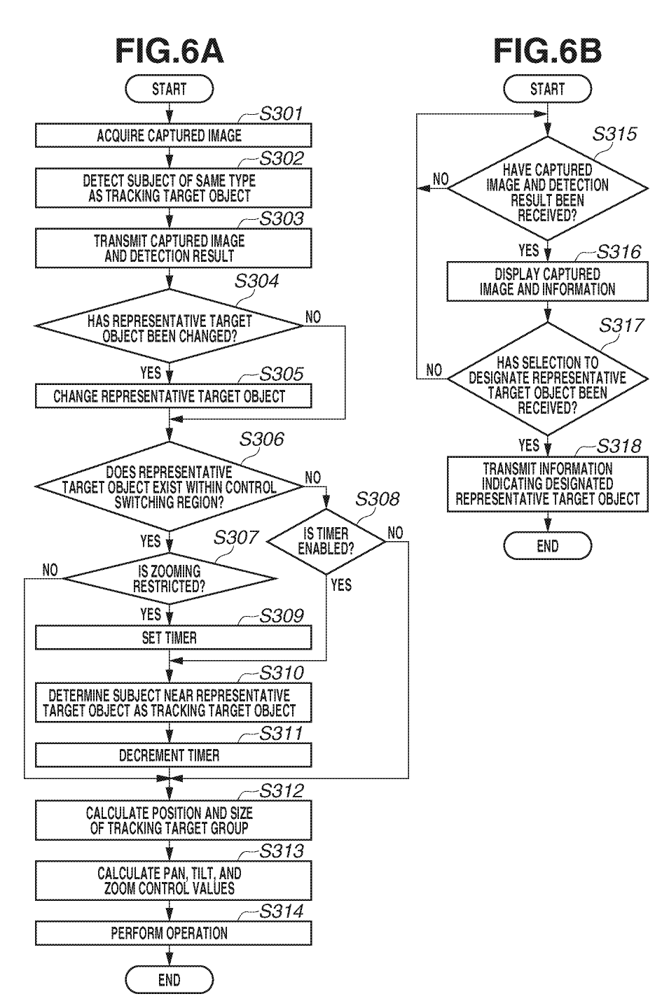

FIGS. 6A and 6B are flowcharts illustrating a tracking process. FIG. 6A illustrates a process in which the camera 100 (the controller 200) tracks a tracking target group, which is a plurality of tracking target objects, and FIG. 6B illustrates a process in which the controller 200 selects a plurality of tracking target objects to be tracked and a representative target object. In the present embodiment, the camera 100 includes first and second modes in which, first, the camera 100 is controlled so that a tracking target group including a plurality of tracking target objects including a representative target object is included within the angle of view. The process in FIG. 6A is started in a case where the camera 100 is set to the first mode and a captured image is generated through image capture by the image capturing sensor 107.

In step S301, the acquisition unit 111 of the camera 100 acquires a captured image generated as a result of image capturing by the image capturing sensor 107.

In step S302, the detection unit 113 of the camera 100 detects a subject of the same type as the tracking target object set by the control unit 115 in the captured image acquired by the acquisition unit 111. In a case where the tracking target object set by the control unit 115 is a person, the detection unit 113 detects a person as a candidate subject for use as a tracking target object in the captured image. In this case, the detection unit 113 detects a subject region, identifies the subject by detecting a feature of the subject, and generates subject identification information.

The processes of steps S301 and S302 may be similar to the processes of steps S101 and S102 illustrated in FIG. 5. Further, in a case where the processes of steps S301 and S302 and the processes of steps S101 and S102 are the same processes performed on the same captured image, the processes of steps S301 and S302 may be omitted.

In step S303, the output unit 114 of the camera 100 transmits the captured image acquired by the acquisition unit 111 and the detection result information obtained by the detection unit 113 to the controller 200.

In step S304, the control unit 115 receives, from the controller 200, designation information regarding a representative target object designated by the user and determines whether the representative target object of the plurality of tracking target objects has been changed, based on the received information. The control unit 115 performs the determination in step S304 by extracting the tracking target objects from the captured image and determining whether the representative target object selected from the extracted tracking target objects is different from the previous one.

In a case where the control unit 115 determines that the representative target object has been changed (YES in step S304), in step S305, the control unit 115 changes the setting for the representative target object based on the information received from the controller 200.

Further, in a case where the control unit 115 determines that the representative target object has not been changed (NO in step S304), the previous representative target object is retained.

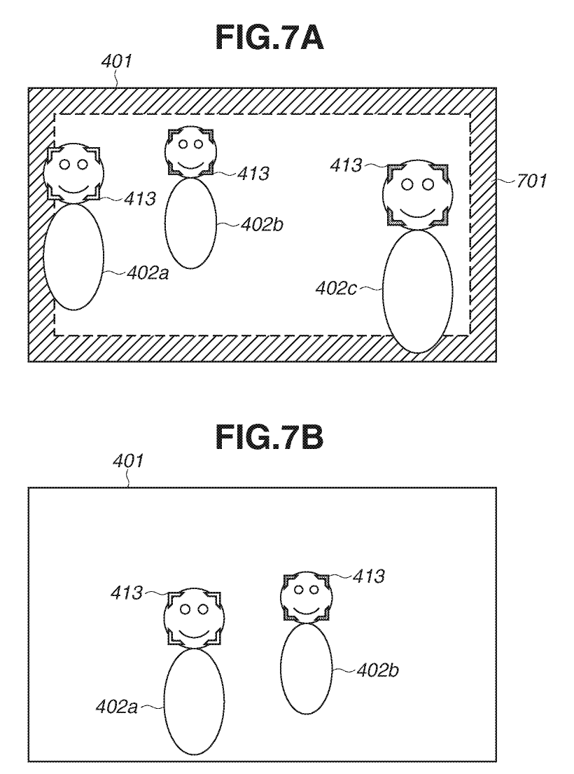

In step S306, the control unit 115 compares the position of the representative target object of the plurality of tracking target objects and a control switching region predetermined for control switching within the angle of view of the image capturing sensor 107 (within the image captured by the image capturing sensor 107), thereby determining whether the representative target object exists within the control switching region. As illustrated in FIG. 7A, in the present embodiment, a region predetermined as a control switching region 701 exists within the captured image 401. The control switching region 701 is configured so that in a case where the representative target object 402a exists within the control switching region 701, the tracking control performed by the camera 100 is set to the second mode. Details of the second mode will be described below.

In the illustrated example, the control switching region 701 is a region indicated by diagonal hatching as an outer edge region in the captured image 401. When the position of the representative target object 402a is within the control switching region 701, the representative target object 402a is in a state where the representative target object 402a is likely to fall outside the captured image 401. Determining such a state and switching the control to the second mode, in which (sight of) the representative target object is less likely to be lost, makes it possible to reduce the likelihood of losing the representative target object 402a. For example, in a case where the representative target object 402a moves from outside the control switching region 701 into the control switching region 701, the camera 100 is controlled by switching from the first mode before the movement to the second mode, thereby switching to tracking control in which the representative target object 402a is prioritized, before the representative target object 402a is lost.

The shape of the control switching region 701 is not limited to the above-described shape, and the control switching region 701 may have any shape. Possible examples include a shape resembling a letterbox on the top and bottom only, a shape including only a rectangular region with four corners as a main portion, and a region outside an ellipse dividing the angle of view. Further, for example, in FIG. 7A, any of the widths of the upper, lower, left, and right sides of the control switching region 701 may be changed by, for example, a user operation as desired. For example, in a case where the representative target object 402a moves quickly in the horizontal direction of the captured image 401, the widths of the left and right sides of the control switching region 701 may be increased (for example, by 15% each) so that the target object is less likely to be lost even in a case where there is a target object that moves faster in the horizontal direction than in the vertical direction. Further, in a case where the representative target object 402a has a large size due to an imaging setting, a width of the control switching region 701 may be increased (for example, the widths of the left and right sides may be increased by 15% each). This makes it possible to advance the timing of control switching determination, thereby making it possible to secure a temporal margin before the representative target object 402a is lost. On the other hand, in order to fully utilize the imaging region of the camera 100, if a control speed for the drive unit 109 permits, a width of the control switching region 701 may be decreased (for example, the widths of the left and right sides may be decreased by 5% each) to allow the position of the representative target object 402a to be up to an end portion of the captured image 401.

Further, a width of the control switching region 701 may be changed based on a moving direction or face orientation of the representative target object 402a. For example, in a case where the representative target object 402a is oriented toward a center of the captured image 401, the representative target object 402a is less likely to move away from the imaging region, so that a width of the control switching region 701 may be decreased.

The control unit 115 determines whether any of the coordinates of the four corners of the rectangle image 413 (refer to FIG. 7A and the like) generated for the representative target object 402a exist within the control switching region 701. In the illustrated example, since two left corners of the rectangle image 413 generated for the representative target object 402a are included within the control switching region 701, the determination condition is satisfied. A method for determining whether the representative target object 402a exists within the control switching region 701 is not limited to the above-described method. For example, whether coordinates of a center point of the rectangle image 413 generated for the representative target object 402a exist within the control switching region 701 may be determined. Further, whether the region indicated by the rectangle image 413 overlaps the control switching region 701 may be determined. Further, a future representative target object may be predicted from a moving speed and a movement trajectory of the representative target object 402a, and whether the rectangle image 413 generated for the future representative target object exists in the control switching region 701 may be determined. Specifically, an indicator for the representative target object 402a used as a basis for the determination in step S306 may be any indicator enabling comparison of the position of the representative target object 402a.

In a case where the position of the representative target object is within the control switching region (YES in step S306), in step S307, the control unit 115 determines whether the zooming operation of the drive unit 109 is restricted by the drive control unit 117 of the camera 100. The control unit 115 performs the determination in step S307 by detecting the stopping of zooming by the drive control unit 117 at a zoom range limit of the drive unit 109 or by control, and determining whether the detected zooming operation is in a restricted state.

In a case where the zooming operation of the drive unit 109 is restricted by the drive control unit 117 (YES in step S307), the control unit 115 switches the control mode in the tracking control of the camera 100 from the first mode to the second mode. In the present embodiment, in the second mode, tracking is performed to prioritize inclusion of the representative target object within the angle of view of the image capturing sensor 107 (the camera 100) over inclusion of a plurality of previously tracked tracking target objects within the angle of view. Specifically, the second mode is a mode in which the camera 100 is controlled to prioritize inclusion of the representative target object within the angle of view even if the number of tracking target objects included within the angle of view becomes less than that in the first mode and/or in a case where the representative target object exists outside the control switching region. In step S309, a duration time is set for a control that "prioritizes imaging of the representative target object", which is preset for a timer for time measurement. The duration time may be set in a case where the timer has no remaining effective duration, and in a case where the timer has a remaining effective duration, the processing proceeds to the next step without setting a time. The duration time for the control that "prioritizes imaging of the representative target object" may be determined by conducting experiments and the like and measuring the time until the control that "prioritizes imaging of the representative target object" control sufficiently stabilizes after a transition of the control. In the present embodiment, the duration time is two seconds. In this case, the control unit 115 sets the timer to two seconds, and the drive control unit 117 performs the control that "prioritizes imaging of the representative target object" for two seconds. The control that "prioritizes imaging of the representative target object" will be described below in step S310.

Further, in a case where the zooming operation of the drive unit 109 is not restricted by the drive control unit 117 (NO in step S307), the processing proceeds to the next step. In this case, the control unit 115 is configured to switch to the control that "prioritizes imaging of the representative target object", because it is determined in step S306 that the position of the representative target object is within the control switching region (YES in step S306). However, in the present embodiment, the control unit 115 does not switch to the control that "prioritizes imaging of the representative target object" in a case where the zooming operation of the drive unit 109 is not restricted. Specifically, in a case where it is determined that imaging can be performed so that the plurality of tracking target objects including the representative target object is included within the angle of view by causing the drive unit 109 to operate the zoom in the wide-angle direction, tracking control need not be switched to the mode that prioritizes imaging of the representative target object. This makes it possible to suppress control switching in a case where the drive unit 109 has sufficient operational margin, thereby reducing an unintended switch to the control that "prioritizes imaging of the representative target object".

In a case where the position of the representative target object is not within the control switching region (NO in step S306), in step S308, the control unit 115 determines whether an effective duration is set for the timer for time measurement. In the present embodiment, in a case where an effective duration is set for the timer, the control unit 115 does not switch to the control that "captures a plurality of tracking target objects". The control is not switched even in a case where it is determined in step S306 to switch to the control that "captures a plurality of tracking target objects" again because the position of the representative target object falls outside the control switching region after switching to the control that "prioritizes imaging of the representative target object". Specifically, even in a case where some of the conditions for switching to the control that "captures a plurality of tracking target objects" are satisfied, if an effective duration is set for the timer of the control unit 115, the control is not switched. This suppresses the tracking control of the camera 100 from being returned to the control that "captures a plurality of tracking target objects" during a transition period from the control that "captures a plurality of tracking target objects" to the control that "prioritizes imaging of the representative target object". Furthermore, the operation time of the control that "prioritizes imaging of the representative target object" can be ensured. Furthermore, hunting resulting from frequent switching of a tracking control can be suppressed.

In a case where an effective duration set for the timer for time measurement remains, i.e., the timer is enabled (YES in step S308), the control unit 115 switches the control mode in the tracking control of the camera 100 from the first mode to the second mode. Further, a tracking target object in the second mode is extracted. In the present embodiment, in the second mode, tracking is performed to prioritize inclusion of the representative target object within the angle of view of the image capturing sensor 107 (the camera 100) over inclusion of a plurality of previously tracked tracking target objects within the angle of view. In the present embodiment, in step S310, one or more subjects near the representative target object are extracted as tracking target objects in order to include as many nearby subjects as possible within the angle of view while the representative target object is tracked and included within the angle of view. Specifically, the control unit 115 re-selects a tracking target object used as a reference for calculating the reference position and size of the tracking target group by the calculation unit 116 of the camera 100. Specifically, any extraction method that makes it possible for the calculation unit 116 to calculate a reference position for the tracking target group to bring the calculated reference position closer to the position of the representative target object (to give priority to inclusion of the representative target object within the angle of view) as a result of re-selection may be employed. Further, the drive control unit 117 is suppressed from rapidly changing the image capturing direction and/or the imaging angle of view of the camera 100 after re-selection of the tracking target object. Specifically, during a predetermined time after re-selection, the control speed of the drive unit 109 by the drive control unit 117 may be reduced relative to the control speed before re-selection, or the zooming operation may be restricted relative to the zooming operation before re-selection. Further, the above description is not intended to be limiting, and the control unit 115 may extract a single subject from the plurality of subjects detected by the detection unit 113 as a tracking target object in the second mode and determine the extracted subject as a tracking target object and as a representative target object.

The captured image 401 in FIG. 7B is an image captured after a predetermined time has elapsed from FIG. 7A, and illustrates a result of extracting the representative target object 402a and the nearby tracking target object 402b during re-selection. In the illustrated example, the other tracking target object 402c exits the frame and is no longer visible in the captured image 401 due to control that prioritizes capturing the representative target object 402a.

In a case where no effective duration is set for the timer for time measurement (NO in step S308), the processing proceeds to the next step.

In step S311, in a case where the timer for time measurement has a remaining effective duration, the control unit 115 decrements the timer count by 1.

In step S312, the calculation unit 116 calculates a reference position and size of the tracking target group.

In step S313, the drive control unit 117 compares the reference position calculated for the tracking target group by the calculation unit 116 and a position set as a target position for the tracking target group in the captured image by the user, and calculates pan and tilt control values based on the comparison result. In this case, the drive control unit 117 determines the pan and tilt direction and speed to bring the reference position calculated for the tracking target group closer to the position set as a target. Further, the drive control unit 117 determines the pan and tilt speed so that the pan and tilt speed increases with increasing positional displacement (distance) between the reference position calculated for the tracking target group and the position set as a target position. In this case, the pan and tilt are controlled to bring the reference position calculated for the tracking target group closer to the target position. The pan and tilt speed with respect to the positional displacement need not be linear, and it is sufficient for a first speed corresponding to the positional displacement of a first position to be higher than a second speed corresponding to the positional displacement of a second position, which is less than the positional displacement of the first position.

Furthermore, in step S313, the drive control unit 117 calculates the difference between the size calculated for the tracking target group by the calculation unit 116 and a value set as a target value for the size of the tracking target group in the captured image by the user, and calculates a zoom control value based on the calculated difference. In this case, the drive control unit 117 determines whether the drive unit 109 is to perform a zoom-in operation or a zoom-out operation to reduce the calculated difference. Further, the drive control unit 117 determines a zoom speed so that the zoom speed increases with increasing calculated difference. In this case, the zoom is controlled to bring the size calculated for the tracking target group closer to the target value.

The drive control unit 117 may determine different zoom speeds for a case where the drive unit 109 is to perform a zoom-in operation and for a case where the drive unit 109 is to perform a zoom-out operation even in a case where the calculated difference is equal. In particular, the drive control unit 117 may set the zoom speed higher in a case where the drive unit 109 is to perform a zoom-out operation than in a case where the drive unit 109 is to perform a zoom-in operation. In this case, tracking responsiveness of the camera 100 to the spread of the tracking target group improves compared to a case where the size of the tracking target group does not change or decreases.

Further, in a case where the camera 100 tracks and captures a tracking target group, the moving speed of the tracking target may increase, and high-speed zooming may be required, compared to a case where the camera 100 tracks and captures a single tracking target object. Thus, the drive control unit 117 may set different zoom speeds for a case where the camera 100 tracks and captures a tracking target group and for a case where the camera 100 tracks and captures a single tracking target object. In particular, the drive control unit 117 may set a higher zoom speed in a case where the camera 100 tracks and captures a tracking target group than in a case where the camera 100 tracks and captures a single tracking target object.

In step S314, the drive control unit 117 controls the drive unit 109 to perform operations based on the content determined in step S313. More specifically, the drive control unit 117 issues an instruction to perform an operation indicated by the content determined in step S313 to the drive unit 109. Consequently, the drive unit 109 performs operations, such as panning, tilting, and zooming, based on the instruction from the drive control unit 117.

In the present embodiment, in a case where no tracking target object is extracted during the current tracking process, the drive control unit 117 does not control the drive unit 109. Further, in a case where only a single tracking target object is extracted during the current tracking process, the drive control unit 117 controls the drive unit 109 to perform panning, tilting, and zooming operations to track the single extracted tracking target object.

The tracking process may be terminated in a case where a termination condition is satisfied after the process in step S314 is performed. Examples of the termination condition include receiving a tracking process termination instruction from the camera 100 or the controller 200, reaching a predetermined date and time, and the expiration of a predetermined time from the start of the tracking process. Further, in a case where the termination condition is not satisfied, the process starting from step S301 may be repeated on a newly generated captured image as a target. The determination of whether the termination condition is satisfied is performed by, for example, the control unit 115.

While an example in which the process of determining whether the zooming operation of the drive unit 109 is restricted is performed in step S307 is described in the present embodiment, this configuration is not essential and may be omitted. Specifically, in a case where the representative target object exists within the control switching region (YES in step S306), in step S309, a duration time for the control that "prioritizes imaging of the representative target object" may be set for the timer for time measurement. This ensures that the tracking control is switched in a case where the representative target object exists within the control switching region (i.e., a case where the representative target object is likely to be lost), thereby reducing the likelihood that the representative target object exits the frame and is lost.

Next, the process illustrated in FIG. 6B in which the controller 200 selects a plurality of tracking target objects to be tracked and a representative target object will be described.

In step S315, the acquisition unit 211 of the controller 200 determines whether the captured image acquired by the acquisition unit 111 of the camera 100 and the detection result information obtained by the detection unit 113 have been received. The acquisition unit 211 performs the determination in step S315 by determining whether only the captured image has been received or the captured image and the detection result information regarding the tracking target objects have been received.

In a case where the captured image and the detection result information regarding the tracking target object have been received (YES in step S315), in step S316, the output unit 214 of the controller 200 displays the captured image transmitted from the camera 100 and the subject identification information on the display unit 206.

In a case where the captured image and the detection result information regarding the tracking target object have not been received (NO in step S315), the processing returns to step S315.

In step S317, the target setting unit 213 determines whether a user selection to designate a tracking target object as a representative target object has been received on the captured image displayed on the display unit 206.

In a case where a user selection to designate a representative target object has been received (YES in step S317), in step S318, the target setting unit 213 transmits information indicating the representative target object designated by the user to the camera 100 via the output unit 214.

In a case where no user selection to designate a representative target object has been received (NO in step S317), the processing returns to step S315.

The processes in steps S315 to S318 may be the same as the processes in steps S104 to S106 illustrated in FIG. 5. Further, in a case where the processes in steps S315 to S318 and the processes in steps S104 to S106 are the same processes performed on the same captured image, the processes in steps S315 to S318 may be omitted.

As described above, in the present embodiment, in a case where the position of the representative target object is not within the control switching region within the angle of view (image) of the image capturing sensor 107 (a case where the representative target object exists outside the control switching region and is less likely to be lost), the tracking control is performed to include the plurality of tracking target objects within the angle of view. On the other hand, in a case where the position of the representative target object is within the control switching region within the angle of view (image) of the image capturing sensor 107 (a case where the representative target object is likely to be lost), the tracking control is performed to prioritize inclusion of the representative target object within the angle of view over inclusion of the plurality of tracking target objects within the angle of view. In this case, the representative target object to which priority is given is prevented from exiting the frame and being lost compared to a case where the tracking control of the camera 100 is not switched regardless of the position of the representative target object of the plurality of tracking target objects. This makes it possible for the camera 100 to control tracking so that at least the representative target object is within the angle of view in a case where it is difficult to track the entire tracking target group, while tracking the tracking target group consisting of the plurality of detected tracking target objects.

Further, while an example in which the image capturing control is performed based on the sizes or lengths of all tracking target objects is described in the present embodiment, this example is not intended to be limiting, and the image capturing control may be performed based on the size of some of the tracking target objects. For example, the image capturing control may be performed based solely on the representative target object or a tracking target object given high priority, such as a subject on which personal authentication has been performed. Specifically, the zoom-out operation of the camera 100 is restricted in a case where the size or length of the tracking target object given relatively high priority is less than a reference and below a lower-limit threshold. At this time, other tracking target objects given relatively low priority may be smaller in size than the reference.

Further, a method for determining a plurality of subjects as tracking target objects is not limited to the above-described method, and other methods may be employed. For example, a specific subject, such as a human FIGURE(face, head portion) or an animal, is detected, and a process of selecting a main subject is performed based on the position and size of the subject within the angle of view detected using personal authentication or the like, a user selection, or the like. Then, the selected main subject may be set as a tracking target object, and nearby subjects located within a predetermined distance from the selected main subject and detected during the specific subject detection process may be grouped and set as tracking target objects.

### Second Embodiment

Next, the image capturing system 1 according to the second embodiment will be described. Regarding the image capturing system 1 according to the second embodiment, configurations different from those of the image capturing system 1 according to the first embodiment are described, and descriptions of configurations similar to those of the image capturing system 1 according to the first embodiment are omitted. Further, in the drawings, components that are the same or similar to those in the first embodiment are assigned the same reference numeral, and redundant descriptions thereof are omitted.

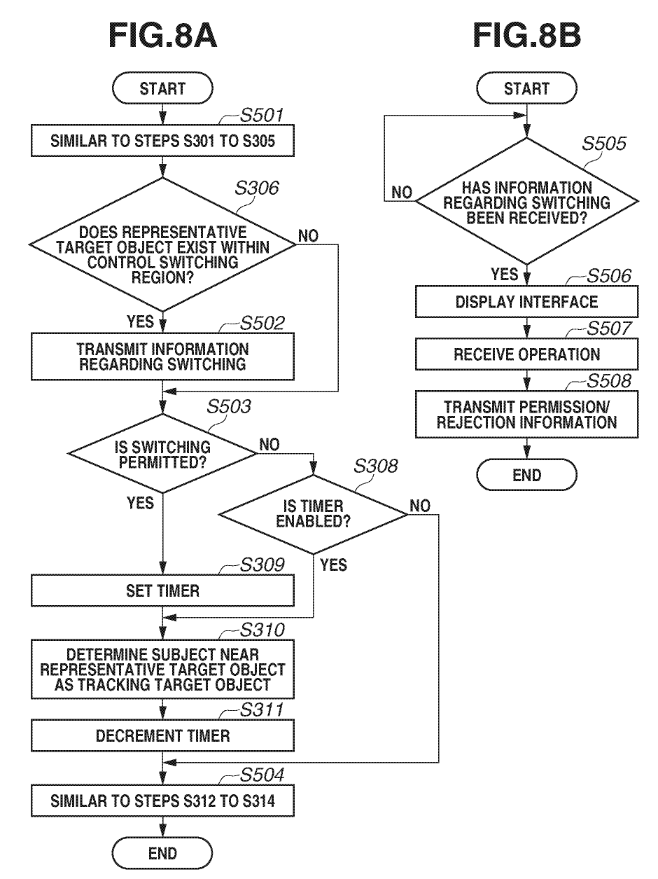

FIG. 8 is a flowchart illustrating a tracking process according to the second embodiment. FIG. 8A illustrates a process in which the camera 100 tracks a tracking target group corresponding to a plurality of tracking target objects, and FIG. 8B illustrates a process performed by the controller 200 in a case where tracking control switching becomes necessary. The processes in steps S501 and S504 in the tracking process illustrated in FIG. 8A are similar to the processes in steps S301 to S305 and S312 to S314 in the tracking process illustrated in FIG. 6A, so that redundant descriptions are omitted.

In step S306, the control unit 115 of the camera 100 compares the position of the representative target object of the plurality of tracking target objects and the control switching region predetermined for control switching and determines whether the representative target object exists within the control switching region.

In a case where the position of the representative target object is within the control switching region (YES in step S306), in step S502, the output unit 114 of the camera 100 transmits information indicating a state permitting control switching to the controller 200.

Further, in a case where the position of the representative target object is not within the control switching region (NO in step S306), the processing proceeds to step S503.

In step S503, the control unit 115 determines whether control switching is permitted, based on the information received from the controller 200.

In a case where control switching is permitted based on the received information (YES in step S503), in step S309, the control unit 115 sets a duration time for the control that "prioritizes imaging of the representative target object", which is preset, in a case where the timer for time measurement has no remaining effective duration. In a case where the timer has a remaining effective duration, the processing proceeds to the next step without setting a new time.

Further, in a case where control switching is not permitted based on the received information (NO in step S503), in step S308, the control unit 115 determines whether an effective duration is set for the timer for time measurement.

In a case where an effective duration is set for the timer for time measurement (YES in step S308), in step S310, the control unit 115 further extracts one or more tracking target objects (including the representative target object) near the representative target object from the extracted tracking target objects.

Further, in a case where no effective duration is set for the timer for time measurement (NO in step S308), the processing proceeds to step S504.

In step S311, in a case where the timer for time measurement has a remaining effective duration, the control unit 115 decrements the timer count by 1.

In step S505, the acquisition unit 211 of the controller 200 determines whether the information indicating a state permitting control switching has been received.

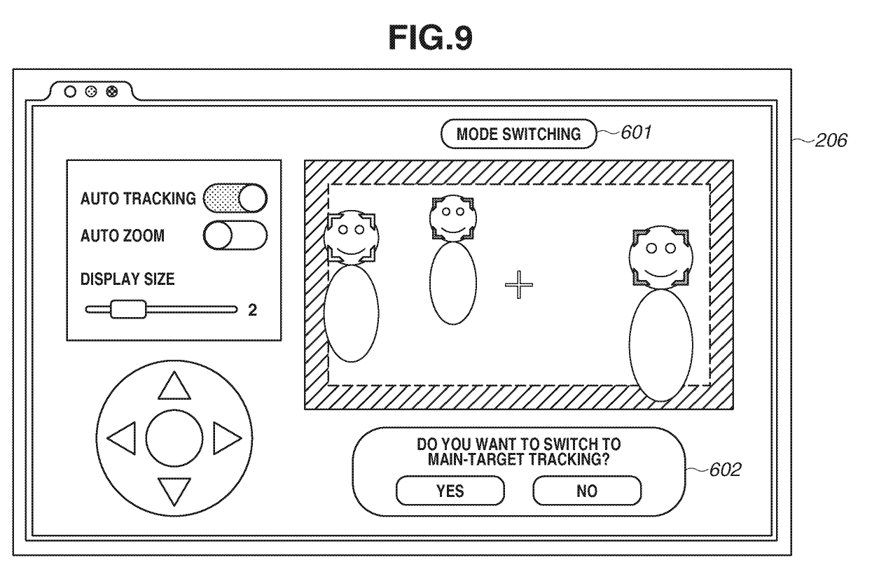

In a case where the information indicating a state permitting control switching has been received (YES in step S505), in step S506, the output unit 214 of the controller 200 displays an item (601 in FIG. 9) indicating the state permitting control switching on the display unit 206. Furthermore, in step S506, the output unit 214 displays an interface (602 in FIG. 9) operable to switch control on the display unit 206.

Further, in a case where the information indicating a state permitting control switching has not been received (NO in step S505), the processing returns to step S505.

In step S507, the target setting unit 213 of the controller 200 receives a user operation to switch control via the interface 602 displayed on the display unit 206. While the interface 602 is displayed so that an operation can be performed to select whether to permit or reject tracking control switching in the present embodiment as illustrated in FIG. 9, this is not intended to be limiting. For example, the display unit 206 may display only an interface used by the user to reject control switching, and in a case where no user operation is performed within a predetermined time, it may be determined that control switching is permitted. Alternatively, the display unit 206 may display only an interface used by the user to permit control switching, and in a case where no user operation is performed within a predetermined time, it may be determined that control switching is rejected. The predetermined time during which a user operation is received is set to ensure that the representative target object is not lost in the captured image and the user has sufficient time to make a determination when performing an operation. Consequently, in the former case, control switching is automatically permitted, and the user is no longer required to perform an operation each time and may perform an operation only when control switching is unnecessary. In the latter case, control switching is automatically rejected, and the user can intentionally switch the control in a case where top priority is given to imaging of the representative target object.

In step S508, the target setting unit 213 transmits information indicating that control switching is permitted by the user or information indicating that control switching is rejected by the user to the camera 100 via the output unit 214. More specifically, in a case where tracking control switching is permitted by the user, the target setting unit 213 generates information indicating permission. Further, in a case where tracking control switching is rejected by the user, the target setting unit 213 generates information indicating rejection.

As described above, in the present embodiment, in a case where the position of the representative target object of the plurality of tracking target objects is within the control switching region, a notification indicating that an operation to switch the tracking control to the control that "prioritizes imaging of the representative target object" can be received is provided, thereby requiring the user to perform a tracking control switching operation.

In this case, the user can recognize when the representative target object to be prioritized exits the frame and is likely to be lost, compared to a case where the tracking control of the camera 100 is not switched regardless of the position of the representative target object of the plurality of tracking target objects. Further, control flexibility is provided to allow the user to select whether to accept loss. Thus, while the camera 100 tracks each of the plurality of detected tracking target objects, in a case where it becomes difficult to track the tracking target group, the user can intentionally control imaging to include the representative target object within the angle of view.

Further, while the controller 200 selects which subject is to be set as a tracking target object in the present disclosure described above, this is not intended to be limiting. For example, the camera 100 may select which subject is to be set as a tracking target object. Specifically, the camera 100 may include the function of the target setting unit 213 of the controller 200.

Further, the camera 100 performs the processes, such as detecting a subject, extracting a tracking target object, and switching between the control that "captures a plurality of tracking target objects" and the control that "prioritizes imaging of the representative target object" in the present disclosure; however, this is not intended to be limiting. For example, the controller 200 may perform the processes, such as detecting a subject, extracting a tracking target object, and switching between the control that "captures a plurality of tracking target objects" and the control that "prioritizes imaging of the representative target object". Specifically, the controller 200 may include the functions of the detection unit 113, the control unit 115, the calculation unit 116, and the drive control unit 117 of the camera 100.

### Other Embodiments

The present disclosure is directed to achieving the above in the following manner. Specifically, a storage medium storing program code of software in which procedures for implementing the functions of each of the above-described embodiments are described is supplied to a system or an apparatus, and a computer (or a CPU, a micro processing unit (MPU), or the like) of the system or the apparatus reads out the program code stored in the storage medium and executes the program code.

In this case, the program code read out from the storage medium itself implements the novel functions of the present disclosure, and the storage medium storing the program code and a program can constitute the present disclosure.

In addition, the present disclosure includes a case in which a software program for implementing the functions of each of the above-described embodiments is supplied to a system or an apparatus having a computer capable of executing the program, either directly from a storage medium or by using wired and/or wireless communication, and the program is executed.

Accordingly, in order to cause a computer to implement the above-described functional processing of the present disclosure, the program code itself that is supplied to and installed in the computer also realizes the present disclosure. That is, a computer program itself for implementing the functional processing of the present disclosure is also included in the present disclosure. In this case, any form of the program may be employed as long as the program has functions as a program, and the program may be object code, a program executed by an interpreter, script data supplied to an operating system (OS), and the like. Examples of a storage medium for supplying the program include a magnetic recording medium such as a hard disk and a magnetic tape, an optical/magneto-optical storage medium, and a nonvolatile semiconductor memory. As a method for supplying the program, a method is conceivable in which a computer program constituting the present disclosure is stored in a server on a computer network and a client computer that has made a connection downloads and programs the computer program.

In addition, based on instructions of the program code, an OS or the like operating on the computer may perform part or all of the actual processing, and the functions of the above-described embodiments may be implemented by the processing. Further, the program code read out from the storage medium may be written into a memory provided in a function expansion board inserted into the computer or a function expansion unit connected to the computer. Then, based on instructions of the program code, a CPU or the like provided in the function expansion board or the function expansion unit may perform part or all of the actual processing. Even in this case, the functions of each of the above-described embodiments are implemented.

As described above, the present disclosure has been described in detail based on embodiments thereof; however, the present disclosure is not limited to the above-described embodiments. Various modifications are possible based on the spirit of the present disclosure, and such modifications are not excluded from the scope of the present disclosure.

According to the present disclosure, it is possible to capture an image while appropriately tracking a tracking target object having a high imaging priority.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-048079, filed Mar. 24, 2025, which is hereby incorporated by reference herein in its entirety.

What is claimed is:

1. An information processing apparatus comprising:
at least one processor; and
a memory storing instructions that cause the at least one processor to:
control an image capturing unit in a first mode to include, within an angle of view of the image capturing unit, a predetermined number of tracking target objects set to be tracked including a representative target object; and
control the image capturing unit in a second mode to include, within the angle of view of the image capturing unit, one or more tracking target objects including the representative target object, the second mode being different from the first mode,
wherein, in a case where the representative target object exists outside a control switching region set within the angle of view of the image capturing unit, the image capturing unit is controlled in the first mode, and
wherein, in a case where the representative target object exists within the control switching region, the image capturing unit is controlled in the second mode.

2. The information processing apparatus according to claim 1, wherein in a case where the representative target object moves from outside the control switching region into the control switching region, the image capturing unit is controlled by switching from the first mode before the movement to the second mode.

3. The information processing apparatus according to claim 1, wherein, in the second mode, the image capturing unit is controlled while prioritizing inclusion of the representative target object within the angle of view of the image capturing unit even in a case where the number of tracking target objects within the angle of view becomes smaller than the number of tracking target objects within the angle of view of the image capturing unit when the representative target object exists outside the control switching region.

4. The information processing apparatus according to claim 1,
wherein the memory stores instructions that cause the at least one processor to further determine whether the representative target object exists within the control switching region, and
wherein switching between the first mode and the second mode is based on an obtained determination result.

5. The information processing apparatus according to claim 1, wherein a timer is configured to continue the second mode for a predetermined time in a case where control of the image capturing unit is switched from the first mode to the second mode.

6. The information processing apparatus according to claim 1,
wherein the memory stores instructions that cause the at least one processor to further detect a subject based on an image captured by the image capturing unit, and
wherein the representative target object is determined based on a detection result and controls the image capturing unit in the first mode or the second mode.

7. The information processing apparatus according to claim 5, wherein whether the representative target object exists within the control switching region is determined based on a detection result.

8. The information processing apparatus according to claim 1, wherein the control switching region is an outer edge region of the angle of view of the image capturing unit.

9. The information processing apparatus according to claim 1,
wherein the image capturing unit is capable of performing a zooming operation, and
wherein the image capturing unit is controlled to include the plurality of tracking target objects within the angle of view of the image capturing unit using the zooming operation.

10. The information processing apparatus according to claim 1, wherein, in a case where the representative target object exists within the control switching region, control is switched from the first mode to the second mode in a state where the zooming operation of the image capturing unit is restricted, and control does not switch from the first mode to the second mode in a state where the zooming operation of the image capturing unit is not restricted.

11. The information processing apparatus according to claim 1, wherein the memory stores instructions that cause the at least one processor to further provide a notification of switching of control between the first mode and the second mode.

12. The information processing apparatus according to claim 1, wherein the memory stores instructions that cause the at least one processor to further receive a user operation to switch between the first mode and the second mode.

13. The information processing apparatus according to claim 12, wherein, in a case where the representative target object exists within the control switching region, switching of control from the first mode to the second mode is received.

14. The information processing apparatus according to claim 1, wherein, in the first mode, the image capturing unit is controlled to include, within the angle of view, the predetermined number of tracking target objects set in advance.

15. The information processing apparatus according to claim 1, wherein, in the second mode, the image capturing unit is controlled based solely on a position of the representative target object.

16. An information processing method comprising:
controlling an image capturing unit, including at least:
a first mode in which the image capturing unit is controlled to include, within an angle of view of the image capturing unit, a predetermined number of tracking target objects set to be tracked including a representative target object; and
a second mode in which the image capturing unit is controlled to include, within the angle of view of the image capturing unit, one or more tracking target objects including the representative target object, the second mode being different from the first mode,
wherein, in a case where the representative target object exists outside a control switching region set within the angle of view of the image capturing unit, the image capturing unit is controlled in the first mode, and
wherein, in a case where the representative target object exists within the control switching region, the image capturing unit is controlled in the second mode.

17. A non-transitory computer-readable storage medium storing a program for causing a computer to execute the information processing method according to claim 16.
